(19) United States
(12) Patent Application Publication
(10) Pub. No.: US 2026/0112265 A1
(43) Pub. Date: Apr. 23, 2026

(54) ALARM PROCESSING METHOD AND APPARATUS, DEVICE, MEDIUM AND PRODUCT

(71) Applicant: Beijing Volcano Engine Technology Co., Ltd., Beijing (CN)

(72) Inventors: Qiang HUANG, Beijing (CN); Jianxin GUO, Beijing (CN); Chen ZHANG, Beijing (CN)

(21) Appl. No.: 19/339,139

(22) Filed: Sep. 24, 2025

(30) Foreign Application Priority Data
Oct. 21, 2024 (CN) 202411472575.3

(51) Int. Cl. G08B 29/00; G08B 31/00

(52) U.S. Cl. CPC G08B 29/00; G08B 31/00

(57) ABSTRACT

The present disclosure provides an alarm processing method, comprising: obtaining a first alarm event; determining at least one analysis step of the first alarm event and at least one data query tool respectively corresponding to the at least one analysis step, and extracting key alarm data from the first alarm event; for each of the at least one analysis step, performing steps of the following: sending the key alarm data and description information of the data query tool to a first language model; receiving query parameters output by the first language model; and calling, based on the query parameters, the data query tool to obtain associated data; sending the first alarm event and the associated data to the first language model, and receiving an alarm analysis result output by the first language model; and processing the first alarm event based on the alarm analysis result.

### CROSS-REFERENCE TO RELATED APPLICATION(S)

The present disclosure claims priority to Chinese Patent Application No. 202411472575.3, filed on Oct. 21, 2024, and entitled “ALARM PROCESSING METHOD AND APPARATUS, DEVICE, MEDIUM AND PRODUCT”, which is hereby incorporated by reference in its entirety.

### FIELD

The present disclosure relates to the technical field of computers, and more specifically, to an alarm processing method and apparatus, an electronic device, a computer readable storage medium and a computer program product.

### BACKGROUND

With the continuous development of cloud computing technology, cloud security protection products for cloud security detection have emerged, including a cloud security center, a cloud workload protection platform (CWPP), and other products designed to protect workloads (e.g. virtual machines, containers) in a cloud environment.

A cloud security protection product can detect alarm information and generate an alarm event. A security operator needs to analyze the alarm event and handle it based on the analysis result. Typically, during analysis of the alarm event, the security operator analyzes the alarm data in the alarm information to obtain an alarm analysis result, which comprises, for example, identifying the cause of the alarm event, determining the scope of impact of the alarm event, and the like, for subsequent alarm processing.

### SUMMARY

The present disclosure provides an alarm processing method. The present disclosure further provides an apparatus, an electronic device, a computer readable storage medium and a computer program product corresponding to the above-mentioned method.

In a first aspect, the present disclosure provides an alarm processing method, comprising:
obtaining a first alarm event;
determining at least one analysis step of the first alarm event and at least one data query tool respectively corresponding to the at least one analysis step, and extracting key alarm data from the first alarm event;
for each of the at least one analysis step, performing steps of the following: sending the key alarm data and description information of a data query tool corresponding to the analysis step to a first language model; receiving query parameters output by the first language model; and calling, based on the query parameters, the data query tool corresponding to the analysis step, to obtain associated data;
sending the first alarm event and the associated data obtained in each of the at least one analysis step to the first language model, and receiving an alarm analysis result output by the first language model; and
processing the first alarm event based on the alarm analysis result.

In a second aspect, the present disclosure further provides an alarm processing apparatus, comprising:
an obtaining module configured to obtain a first alarm event;
a determining module configured to determine at least one analysis step of the first alarm event and at least one data query tool respectively corresponding to the at least one analysis step, and extract key alarm data from the first alarm event;
an analyzing module configured to perform, for each of the at least one analysis step, steps of the following: sending the key alarm data and description information of a data query tool corresponding to the analysis step to a first language model; receiving query parameters output by the first language model; and calling, based on the query parameters, the data query tool corresponding to the analysis step, to obtain associated data;
a communication module configured to send the first alarm event and the associated data obtained in each of the at least one analysis step to the first language model, and receive an alarm analysis result output by the first language model; and a processing module configured to process the first alarm event based on the alarm analysis result.

In a third aspect, the present disclosure provides an electronic device, comprising a processor and a memory. The processor and the memory can communicate with each other. The processor is used for executing instructions stored in the memory, to cause the electronic device to perform the alarm processing method in the first aspect or according to any of implementations in the first aspect.

In a fourth aspect, the present disclosure provides a computer readable storage medium having instructions stored thereon, which instruct the electronic device to perform the alarm processing method in the first aspect or according to any of implementations in the first aspect.

In a fifth aspect, the present disclosure provides a computer program product comprising instructions, where the instructions, when running on an electronic device, causes the electronic device to perform the alarm processing method in the first aspect or according to any of implementations in the first aspect.

On the basis of implementations provided in the aspects described above, the present disclosure can provide more implementations by further combining those implementations.

### BRIEF DESCRIPTION OF THE DRAWINGS

In order to make clearer the technical method according to embodiments of the present disclosure, a brief description of drawings required in the embodiments will be provided below.

FIG. 1 illustrates a schematic flowchart of an alarm processing method according to embodiments of the present disclosure;

FIG. 2 illustrates a schematic flowchart of an alarm processing method according to embodiments of the present disclosure;

FIG. 3 illustrates a schematic flowchart of creating an alarm database according to embodiments of the present disclosure;

FIG. 4 illustrates a schematic diagram of a structure of an alarm processing apparatus according to embodiments of the present disclosure; and

FIG. 5 illustrates a schematic diagram of a structure of an electronic device according to embodiments of the present disclosure.

### DETAILED DESCRIPTION OF EMBODIMENTS

The terms “first” and “second” as used herein are only intended for the purpose of description, and should not be construed as an indication or implication of relative importance or implicit indication of a quantity of indicated technical features. Therefore, the feature modified by “first” or “second” may explicitly or implicitly comprise one or more features.

Hereinafter, an introduction will be provided about some technical terms and application scenarios involved in the embodiments of the present disclosure.

With the continuous development of cloud computing technology, cloud security protection products for cloud security detection have emerged. The cloud security protection products can perform security detection in multiple aspects of multiple operation scenarios. For example, the cloud security protection product may be a cloud workload protection platform (CWPP) that can perform detection with respect to host security and network security. For another example, the cloud security protection product may be a host-based intrusion detection system (HIDS) that can perform security detection for behavior or a state of a computer system. For a further example, the cloud security protection product may be endpoint detection and response (EDR) that can perform security detection for system-level behavior of an endpoint. For a still further example, the cloud security protection product may be a container security platform (CSP) that can provide multi-faceted security detection for containers.

In example implementations, the cloud security protection product can detect alarm information and generate an alarm event. Then, a security operator can analyze the generated alarm event, and perform alarm processing in conjunction with the alarm analysis result.

In related technologies, the security operator can analyze the alarm event using a standard operating procedure (SOP) document. For example, the SOP document contains records about historical analysis processes for different alarm events, and the security operator can filter out a historical analysis process similar to the current alarm event from the SOP document, and analyze the alarm event based on the historical analysis process, to obtain an alarm analysis result.

In general, the security operator can perform alarm analysis by analyzing alarm data in alarm information. For instance, by analyzing alarm data in alarm information, the security operator can identify a cause for generating an alarm event, determine scope of impact of the alarm event, and the like.

However, the above method relies heavily on human resources, resulting in low efficiency of alarm analysis. Moreover, the method of analyzing the alarm data in the alarm information makes it difficult to obtain a comprehensive alarm analysis result, leading to low accuracy and specificity of alarm processing.

In view of the above, the present disclosure provides an alarm processing method, comprising: obtaining a first alarm event; determining at least one analysis step of the first alarm event and at least one data query tool respectively corresponding to the at least one analysis step, and extracting key alarm data from the first alarm event; for each of the at least one analysis step, performing steps of the following: sending the key alarm data and description information of a data query tool corresponding to the analysis step to a first language model; receiving query parameters output by the first language model; and calling, based on the query parameters, the data query tool corresponding to the analysis step, to obtain associated data; sending the first alarm event and the associated data obtained in each of the at least one analysis step to the first language model, and receiving an alarm analysis result output by the first language model; and processing the first alarm event based on the alarm analysis result.

In the method, the process of analyzing an alarm event is divided into a plurality of analysis steps, where, in each analysis step, associated data related to the alarm event are obtained based on key alarm data in the alarm event, and the associated data from each analysis step are used to analyze the alarm event. In this way, the obtained alarm analysis result is more comprehensive and more diversified, enabling accurate and targeted alarm processing. In addition, natural language processing capabilities of language models are utilized to determine query parameters for calling a data query tool and generate an alarm analysis result, enabling the automation of the alarm event analysis process and improving the efficiency of alarm analysis.

For ease of understanding of the technical solution provided by embodiments of the preset disclosure, reference below will be made be to the drawings.

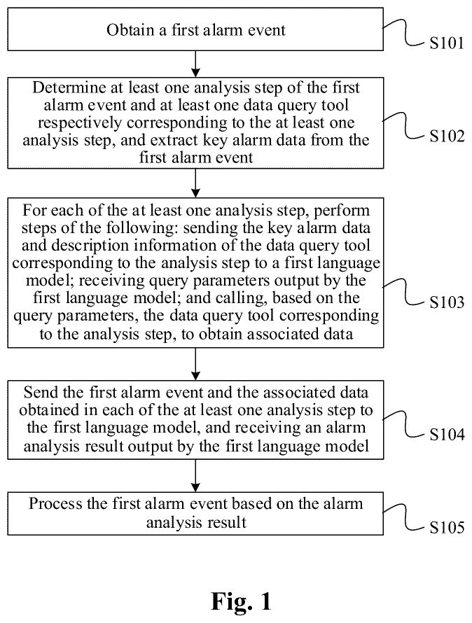

FIG. 1 illustrates a schematic flowchart of an alarm processing method provided by embodiments of the present disclosure. The method comprises:

S101: a first alarm event is obtained.

In the embodiments of the present disclosure, the first alarm event may be any alarm event generated by a cloud security protection product. In other words, a user can use a cloud security protection product to detect a computing device or a virtual operating environment, and when an abnormality occurs to the computing device or virtual operating environment, the cloud security protection product generates a first alarm event.

Typically, the first alarm event may be related to at least one piece of alarm information. Wherein, the alarm information can be read as information related to the abnormality generated in the computing device or the virtual operating environment. For example, the alarm information may be information related to malware, information related to intrusion, information related to vulnerabilities, or the like.

In example implementations, the first alarm event may be generated based on an alarm rule. Wherein, the alarm rule can be read as a rule for generating an alarm event from alarm information. The cloud security product continuously obtains alarm information, and when at least piece of alarm information hits a certain alarm rule, a first alarm event is generated.

In some embodiments, the cloud security protection product may be a software system, for example, a software system deployed locally or in a cloud. In the case, the server for alarm processing provided by embodiments of the present disclosure can be integrated into the cloud security protection product in the form of a plugin, a cloud service, or the like.

S102: at least one analysis step of the first alarm event and at least one data query tool respectively corresponding to the at least one analysis step are determined, and key alarm data is extracted from the first alarm event.

In the embodiments of the present disclosure, the analysis steps may be steps for analyzing the first alarm event. It is to be appreciated that the alarm analysis generally has a standard process, i.e., alarm analysis can be performed according to a certain logical sequence. The analysis steps can be read as steps comprised in the standard process, or steps forming the logical sequence.

The data query tool can be read as a tool for retrieving data, such as software, a component, a cloud service, or the like, for retrieving data. In the embodiments of the present disclosure, the data query tool can be used for retrieving associated data related to the first alarm event, i.e., the data query tool may be software, a component, a cloud service, or the like, for retrieving related data of the computing device or the virtual operating environment.

In the embodiments of the present disclosure, an analysis step may correspond to a data query tool. In other words, in each analysis step, a corresponding data query tool can be used for retrieving data, to thus obtain associated data. Accordingly, when at least one analysis step for the first alarm event is performed in different dimensions, corresponding data query tools can be used to obtain associated data of different dimensions and types.

In general, alarm events of the same alarm type correspond to the same alarm analysis process. In other words, for alarm events of the same alarm type, the same analysis steps and the same data query tools respectively corresponding to the analysis steps are employed. For example, a target alarm type of the first alarm event is identified, an alarm analysis script corresponding to the target alarm type is executed, and at least one analysis step for the first alarm event and at least one data query tool respectively corresponding to the at least one analysis step are determined.

The target alarm type can be read as an alarm type of the first alarm event, and the alarm analysis script can be read as a script containing at least one analysis step for the alarm event, and at least one data query tool respectively corresponding to the at least one analysis step.

Wherein, the script is a series of sets of instructions for controlling the operations of the computing device, which can be read and executed by the computing device. In other words, the alarm analysis script in the embodiments of the present disclosure comprises sets of instructions respectively for dividing the alarm analysis of the target alarm type into different analysis steps and determining data query tools corresponding to the respective analysis steps. By providing and executing the alarm analysis script, at least one analysis step and at least one data query tool respectively corresponding to the at least one analysis step can be generated automatically, thereby improving the efficiency and the intelligence of alarm analysis.

In some possible implementations, the alarm analysis script can be obtained through conversion from a standard operating procedure (SOP) document. Wherein, the SOP document is typically represented in a natural language, which records an alarm analysis process performed by the security operator. In other words, the SOP document comprises an alarm analysis record related to the alarm analysis process.

In an example implementations, a SOP document is obtained and then sent to a second language model. Then, the second language model identifies an alarm type from the SOP document, extract analysis steps and determines data query tools, and generates an alarm analysis script. Next, the alarm analysis script corresponding to the alarm type output by the second language model is received.

The second language model has natural language processing capabilities, which can understand a natural language and process different types of natural language tasks. For example, the second target model may be a deep learning model trained using text data. In the embodiments of the present disclosure, since the SOP document is represented in a natural language, the natural language processing capabilities of the language model can be used to identify and analyze the SOP document, and convert the SOP document in the natural language into an alarm analysis script readable and executable by the computing device.

The second language model can generate an alarm analysis script using a prompt learning method. Wherein, prompts in a generative task (e.g. a text generation task, a question-answering task, or a dialogue task) can introduce a language model to generate a specific output. By configuring the prompts, the present disclosure can assist the language model in understanding the background and requirements of the task, and enable the language model to process different types of natural language processing tasks, without re-training the language model, thereby improving the scalability and flexibility of the language model.

In the embodiments of the present disclosure, the prompts may comprise content that instructs the second language model to extract the analysis steps from the SOP document. For example, the prompts may comprise content that instructs the second language model to extract, from the SOP document, information such as a timestamp, an execution user, an execution action, platform information, an operation resource object, and the like, and determine at least one analysis step based on the extracted information. In this way, with the prompting capability of the prompts, the second language model can convert the alarm analysis record in the SOP document into at least one analysis step.

In addition, the prompts may further comprise description information of different data query tools, and content that instructs the second language model to determine a data query tool corresponding to each analysis step. Wherein, the description information of a data query tool may be read as information for describing functions, input parameters, output parameter, and the like, of the data query tool. Therefore, with the prompting capability of the prompts, the second language model can determine, based on the alarm analysis record in the SOP document, at least one data query tool respectively corresponding to the at least one analysis step, to thus obtain the alarm analysis script.

In some embodiments, the SOP documents are pre-classified based on alarm types. The second language model is used to identify and analyze SOP documents of different alarm types, and generate alarm analysis scripts corresponding to different alarm types. For example, the SOP documents comprise an SOP document A of an alarm type A, and an SOP document B of an alarm type B. In the case, the second language module can identify and analyze the SOP document A of the alarm type A, and generate an alarm analysis script corresponding to the alarm type A; and the second language module can identify and analyze the SOP document B of the alarm type B, and generate an alarm analysis script corresponding to the alarm type B.

In some other embodiments, the SOP documents are not pre-classified, i.e., the SOP documents comprise alarm analysis records of different alarm types. The second language mode is used to identify and analysis the SOP documents, to generate alarm analysis scripts, and then classify the alarm analysis scripts, to obtain alarm analysis scripts corresponding to different alarm types. For example, the SOP document A comprises an alarm analysis record for an alarm event of the alarm type A, and an alarm analysis record for an alarm event of the alarm type B; the second language module identifies and analyzes the SOP document A, and generates alarm analysis scripts; and the second language module is further used to classify the alarm analysis scripts based on the alarm types, to obtain an alarm analysis script corresponding to the alarm type A, and an alarm analysis script corresponding to the alarm type B.

Key alarm data in a first alarm event may be alarm data in at least one piece of alarm information related to the first alarm event. In the embodiments of the present disclosure, the key alarm data may be data corresponding to a key field in at least one piece of alarm information related to the first alarm event. For example, the key field may comprise a detection time field, an operation status field, an impact scope field, a detection source field, an account identifier field, a security credential access key (AK) field, a service name field, a service area field, a call interface field, a call interface version field, an internet protocol (IP) address field, and the like.

S103: for each of the at least one analysis step, the following steps are performed: sending the key alarm data and description information of a data query tool corresponding to the analysis step to a first language model; receiving query parameters output by the first language model; and calling, based on the query parameters, the data query tool corresponding to the analysis step, to obtain associated data.

After the at least one analysis step of the first alarm event is determined, the respective analysis steps can be performed automatically according to the execution sequence, and associated data can be obtained in each analysis step.

In the embodiments of the present disclosure, in each analysis step, the first language model is used to determine query parameters. Wherein, the query parameters may be read as parameters required for calling a data query tool. In the embodiments of the present disclosure, the query parameters can be extracted from key alarm data of the first alarm event.

Similar to the second language model, the first language model has natural language processing capabilities, which can understand a natural language and process different types of natural language tasks. For example, the first target model may be a deep learning model trained using text data.

Similarly, the first language model can determine query parameters using a prompt learning method. Wherein, the prompts may comprise content that instructs the first language model to determine query parameters from the alarm key data in conjunction with description information of a data query tool. Accordingly, with the prompting capability of the prompts, the first language model can determine a parameter field required for calling a data query tool from the description information of a data query tool, and can extract query parameters matching the parameter field from the alarm key data.

After the first language model outputs the query parameters, the query parameters are used to call the data query tool, to thus obtain associated data related to the first alarm event. In some embodiments, the first alarm event is related to at least one of a target device, a target account, or a target service. For example, the first alarm event may be an alarm event generated after an abnormality occurs to the at least one of the target device, the target account, or the target service. In the case, the associated data may comprise at least one of: process logs of the target device, access behavior logs of the target account, or service data of the target service.

In other words, the associated data may comprise data related to a device, an account or a service involved in the first alarm event. Hereinafter, description will be made to different data query tools. When the data query tool is a tool that enables a query about a security credential AK through an account name, the query parameters may comprise the account name, and a timestamp. When the data query tool is a tool that enables a query about a security credential AK through an AK, the query parameters may comprise the AK, and a timestamp. When the data query tool is a tool that enables a query about a security credential AK through an account identifier, the query parameters may comprise the account identifier, and a timestamp. When the data query tool is a tool that enables a query about a security credential AK through an IP address, the query parameter may comprise the IP address, and a timestamp. When the data query tool is a tool that enables a query about an operation log from a multi-cloud system, the query parameters may comprise the account identifier and a timestamp. When the data query tool is a tool that enables a query about a process log, the query parameters may comprise an IP address, a host identifier, and a timestamp. When the data query tool may be a tool that enables a query about an access behavior log, the query parameters may comprise a host identifier, an account identifier, and a timestamp. When the data query tool is a tool that enables a query about service data, the query parameters may comprise a security credential AK, a service identifier, and a timestamp.

In this way, using different data query tools corresponding to different analysis steps, associated data of different dimensions and types can be obtained, which indicates that more data associated with the first alarm event can be obtained, thereby enabling more accurate identification of the cause of the first alarm event and implementing targeted alarm processing.

S104: the first alarm event and the associated data obtained in each of the at least one analysis step are sent to the first language model, and an alarm analysis result output by the first language model is received.

In the embodiments of the present disclosure, after the associated data in each analysis step are obtained, the first language model is used to analyze the first alarm event in conjunction with the associated data obtained in each analysis step, to obtain an alarm analysis result.

Similarly, the first language model can generate an alarm analysis result using a prompt learning method. Wherein, prompts may comprise content that instructs the first language model to analyze the first alarm event in conjunction with the associated data obtained in each analysis step. Therefore, with the prompting capability of the prompts, the first language model can analyze the associated data and the at least one piece of alarm information related to the first alarm event together, identify the root cause of the alarm, locate the source of the problem, analyze alarm trends, identify content that requires special attention, and then generate the alarm analysis result.

S105: the first alarm event is processed based on the alarm analysis result.

After an alarm analysis result of the first alarm event is obtained from analysis on the first alarm event, targeted processing can be performed for the first alarm event based on the content of the alarm analysis result.

In some embodiments, the alarm analysis result may comprise information for processing the first alarm event. For example, at least one processing tool and processing parameters corresponding to the at least one processing tool can be determined based on the alarm analysis result; and then, at least one processing tool can be called based on the processing parameters, to process the first alarm event.

In other words, the alarm analysis result output by the first language model comprises a recommended processing method for the first alarm event, and comprises a processing tool required for processing the first alarm event, and processing parameters for calling the processing tool. In this way, the processing parameters are used to call the processing tool, to implement automatic processing of the first alarm event and improve the alarm processing efficiency. Moreover, since the alarm analysis result is generated based on a variety of multi-dimensional associated data, more accurate alarm processing can be implemented.

In the method, the process of analyzing an alarm event is divided into a plurality of analysis steps, where, in each analysis step, data associated with the alarm event are obtained based on key alarm data in the alarm event, and the associated data from each analysis step are used to analyze the alarm event. In this way, the obtained alarm analysis result is more comprehensive and more diversified, enabling accurate and targeted alarm processing. In addition, natural language processing capabilities of language models are utilized to determine query parameters for calling a data query tool and generate an alarm analysis result, enabling the automation of the alarm event analysis process and improving the efficiency of alarm analysis, thereby enhancing the security protection capabilities of cloud security products such as a cloud workload protection platform (CWPP), a cloud security center, and a container security protection platform.

The description above has been made to the alarm processing method provided by the embodiments of the present disclosure. Hereinafter, the alarm processing method will be detailed in conjunction with a specific scenario.

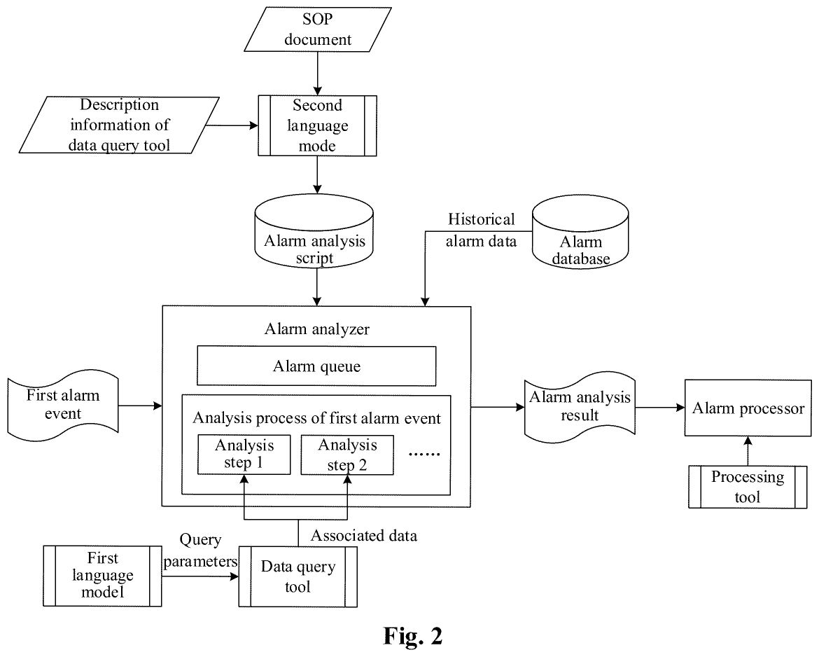

FIG. 2 illustrates a schematic flowchart of an alarm processing method. A server for alarm processing provided by the embodiments of the present disclosure may comprise an alarm analyzer, and an alarm processor, where the alarm analyzer is used for automatically analyzing an alarm event, and an alarm processor is used for automatically processing an alarm event.

For example, the second language model can convert a SOP document described in a natural language into an alarm analysis script readable and executable by a computing device, based on the description information of the query tool. When the first alarm event occurs, the alarm analyzer executes an alarm analysis script corresponding to a target alarm type of the first alarm event, and determines at least one analysis step (e.g., an analysis step 1, an analysis 2, . . . ) and a data query tool corresponding to each analysis step.

For each analysis step, the alarm analyzer calls the first language model; the first language model determines query parameters based on key alarm data and description information of a data query tool corresponding to the analysis step; the alarm analyzer calls a data query tool based on the query parameters, to obtain the associated data. After obtaining the associated data from each analysis step, the alarm analyzer calls the first language model; then, the first language model analyzes the first alarm event based on the associated data from each analysis step, and generates an alarm analysis result, where the alarm analysis may comprise a processing tool, and processing parameters corresponding to the processing tool.

The alarm analyzer sends the alarm analysis result to the alarm processor. The alarm processor calls a corresponding processing tool based on the processing parameters, to process the first alarm event. Thus, the alarm processing process is completed.

In some embodiments, as shown in FIG. 2, the alarm analyzer can perform alarm analysis based on historical alarm data. For example, historical alarm data can be obtained from an alarm database, where the historical alarm data comprise alarm data of an alarm event of the same alarm type as the first alarm event, and/or alarm data similar to key alarm data of the first alarm event.

The alarm database may be read as a database containing a plurality of pieces of alarm data within a historical time period. Typically, the alarm data in the alarm database have been subjected to alarm processing, i.e., the alarm database may comprise processing information on the plurality of pieces of alarm data within the historical time period, and the alarm data and the processing information corresponding thereto in the alarm database can be stored in association.

In the embodiments of the present disclosure, alarm data similar to the first alarm event is filtered out from the alarm database, which may be, for example, alarm data of an alarm event of the same alarm type, or alarm data similar to the key alarm data of the first alarm event. Since the historical alarm data are similar to the first alarm event and has subjected to alarm processing, alarm analysis can also be performed on the historical alarm data in the process of alarm analysis of the first alarm event, so as to make data types and data dimensions further diversified.

In the example implementations, the first alarm event, and the associated data and historical alarm data obtained in each analysis step are sent to the first language model, and an alarm analysis result output by the first language model is received. In the case, the prompts may comprise content that instructs the first language model to analyze the first alarm event based on the associated data and the historical alarm data obtained in each analysis step. In this way, with the prompting capability of prompts, the first language model can analyze the associated data, the historical alarm data, and at least one piece of alarm information related to the first alarm event, to generate an alarm analysis result, which can enhance the accuracy of the alarm analysis.

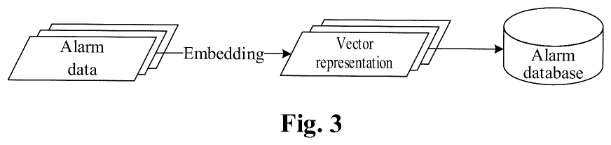

Hereinafter, description will be made to a process of creating an alarm database. FIG. 3 illustrates a schematic flowchart of creating an alarm database, which comprises: obtaining a plurality of pieces of alarm data; performing embedding on the plurality of pieces of alarm data, and determining vector representations corresponding to the plurality of pieces of alarm data; and creating the alarm database based on the vector representations corresponding to the plurality of pieces of alarm data.

The embedding may be understood as a process of converting information represented in text into information represented in vectors. For example, the embedding may comprise: segmenting text of alarm data, to generate an alarm data block; performing embedding on the alarm data block using a vector model, to generate a vector representation of the alarm data block; and storing the vector representation of the alarm data block into the alarm database.

In the embodiments of the present disclosure, the alarm data are stored in the alarm database in the form of vector representations, and when the alarm analyzer retrieves historical alarm data from the alarm database, efficient retrieval can be achieved, which can improve the efficiency of obtaining historical alarm data and thereby enhance the alarm analysis efficiency.

Continuing with FIG. 2, the alarm analyzer can perform alarm analysis on a plurality of alarm events which can be arranged in the form of an alarm queue. Wherein, the alarm queue may comprise an alarm event to be processed in a current alarm processing process which may be read as an alarm processing process triggered by the first alarm event.

In the example implementations, in response to the associated data obtained in at least one analysis step hitting an alarm rule, a second alarm event is generated, and then added to the alarm queue.

That is, in the embodiments of the present disclosure, after the first alarm event occurs, associated data can be obtained in each analysis step for analyzing the first alarm event; a new alarm event can be generated based on the associated data obtained from each analysis step, where the alarm event generated based on the associated data may belong to the same alarm processing process as the first alarm event.

In other words, in addition to the first alarm event, the alarm queue may comprise a second alarm event generated based on the associated data obtained in each analysis step for the first alarm event. Therefore, on one hand, the associated data can be used for assisting in alarm analysis, and on the other hand, it can be used for automatically detecting other alarm events associated with the first alarm event. In this way, the present disclosure can accelerate the operation efficiency of the cloud security protection product, and ensure the security of the computing device or virtual operating environment.

Considering that the analysis process of the first alarm event may cover a plurality of analysis steps, where more associated data may be obtained from each analysis step, a verification operation can be added in each analysis step according to the embodiments of the present disclosure. For example, in response to a data query tool corresponding to a first analysis step being identical to a data query tool corresponding to a second analysis step, and query parameters in the first analysis step being identical to query parameters in the second analysis step, it is refused to execute the operation of calling the data query tool corresponding to the second analysis step.

The first analysis step and the second analysis step are any two analysis steps in the current alarm processing process, and the second analysis step is after the first analysis step. That is, after the first language model outputs the query parameters, the alarm analyzer can determine whether the data query tool and query parameters in a current analysis step are consistent with those in the executed analysis step in the current alarm processing process. If yes, it is indicated that the associated data obtained in the analysis step are consistent with those obtained in the executed analysis step of the current alarm processing process. In the case, it is refused to perform the operation of calling the data query tool to obtain associated data in this analysis step, to avoid repeatedly obtaining the associated data while saving the computing resources.

By way of example, analysis for the first alarm event comprises an analysis step 1 and an analysis step 2. The analysis step 1 corresponds to a data query tool A. In the analysis step 1, the first language model outputs the query parameters A, and the alarm analyzer calls the query tool A based on the query parameters A, to obtain associated data A. The analysis step 2 corresponds to the data query tool A. In the analysis step 2, the first language model outputs the query parameters A; the alarm analyzer determines that the data query tool corresponding to the analysis step 2 is identical to the data query tool corresponding to the analysis step 1 and the query parameters in the analysis step 2 are identical to those in the analysis step 1, and therefore does not perform the operation of calling the data query tool in the analysis step 2.

In some other examples, the alarm queue further comprises a second alarm event. After the analysis process of the first alarm event is completed, the alarm analyzer can analyze the second alarm event. The analysis of the second alarm event comprises an analysis step 3. The analysis step 3 corresponds to the data query tool A. In the analysis step 3, the first language model outputs the query parameters A; and the alarm analyzer determines that the data query tool corresponding to the analysis step 3 is identical to the data query tool corresponding to the analysis step 1 and the query parameters in the analysis step 3 are identical to those in the analysis step 1, and therefore does not perform the operation of calling the data query tool in the analysis step 3.

Further, considering that the same associated data may be obtained using different query parameters or different data query tools, a data judgment operation can be added in each analysis step according to the embodiments of the present disclosure. For example, in response to associated data obtained in a third analysis step being identical to associated data obtained in a fourth step, the associated data obtained in the fourth analysis step are discarded.

The third analysis step and the fourth analysis step are any two analysis steps in the current alarm processing process, and the fourth analysis step is after the third analysis step. That is to say, after calling a data query tool corresponding to a certain analysis step and obtaining the associated data of this analysis step, the alarm analyzer can determine whether the associated data obtained in this analysis step are consistent with the associated data obtained in the executed analysis step of the current alarm processing process. If yes, the associated data obtained in the analysis step are discarded, i.e., the operation of calling the data query tool in the analysis step is neglected, to avoid using the same associated data to analyze the alarm event while preventing the same alarm event from being generated using the same associated data, and thus avoid adding the same alarm event to the alarm queue.

By way of example, the analysis of the first alarm event comprises an analysis step 1 and an analysis step 2. The analysis step 1 corresponds to a data query tool A. In the analysis step 1, the first language model outputs the query parameter A, and the alarm analyzer calls the data query tool A based on the query parameters A, to obtain the associated data A. The analysis step 2 corresponds to a data query tool B. In the analysis step 2, the first language model outputs query parameters B, and the alarm analyzer calls the data query tool B based on the query parameters B, to obtain the associated data A. The alarm analyzer determines that the associated data obtained in the analysis step 2 are identical to those obtained in the analysis step 1, and therefore discards the associated data obtained in the analysis step 2.

In some other examples, the alarm queue further comprises a second alarm event. After completing the analysis process of the first alarm event, the alarm analyzer can analyze the second alarm event. The analysis of the second alarm event comprises an analysis step 3. The analysis step 3 corresponds to a data query tool C. In the analysis step 3, the first language model outputs query parameters C; and the alarm analyzer determines that the associated data obtained in the analysis step 3 are identical to those obtained in the analysis step 1, and therefore, discards the associated data in the analysis step.

Reference above have been made to FIGS. 1-3 for detailing the alarm processing method provided by the embodiments of the present disclosure. Hereinafter, an apparatus and a device provided by embodiments of the present disclosure will be described with reference to the drawings.

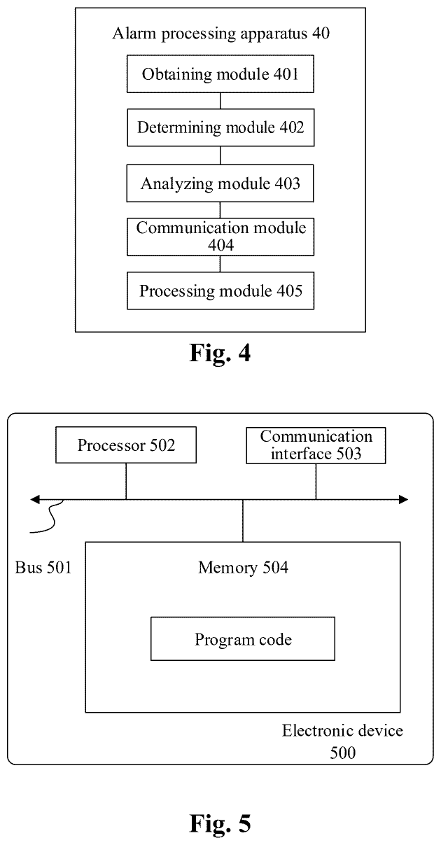

FIG. 4 illustrates a schematic diagram of a structure of an alarm processing apparatus. The apparatus 40 comprises:
an obtaining module 401 configured to obtain a first alarm event;
a determining module 402 configured to determine at least one analysis step of the first alarm event and at least one data query tool respectively corresponding to the at least one analysis step, and extract key alarm data from the first alarm event;
an analyzing module 403 configured to perform, for each of the at least one analysis step, steps of the following: sending the key alarm data and description information of a data query tool corresponding to the analysis step to a first language model; receiving query parameters output by the first language model; and calling, based on the query parameters, the data query tool corresponding to the analysis step, to obtain associated data;
a communication module 404 configured to send the first alarm event and the associated data obtained in each of the at least one analysis step to the first language model, and receive an alarm analysis result output by the first language model; and
a processing module 405 configured to process the first alarm event based on the alarm analysis result.

In some possible implementations, the determining module 402 is used for:
identifying a target alarm type of the first alarm event; and
executing an alarm analysis script corresponding to the target alarm type, and determining the at least one analysis step of the first alarm event and the at least one data query tool respectively corresponding to the at least one analysis step.

In some possible implementations, the alarm analysis script is determined by:
obtaining a standard operating procedure (SOP) document comprising an alarm analysis record characterized in a natural language;
sending the SOP document to a second language model to cause the second language model to identify an alarm type from the SOP document, extract an analysis step and determine a data query tool, and generate an alarm analysis script; and
receiving the alarm analysis script corresponding to the alarm type and output by the second language model.

In some possible implementations, the first alarm event is related to at least one of a target device, a target account or a target service; and
the associated data comprises at least one of the following: a process log of the target device, an access behavior log of the target account or service data of the target service.

In some possible implementations, the apparatus 40 further comprises a generation module for: in response to the associated data obtained in the at least one analysis step hitting an alarm rule, generating a second alarm event; and
adding the second alarm event to an alarm queue, wherein the alarm queue comprises an alarm event to be processed in a current alarm processing process.

In some possible implementations, the apparatus 40 further comprises an execution module for:
in response to a data query tool corresponding to a first analysis step being identical to a data query tool corresponding to a second analysis step, and query parameters in the first analysis step being identical to query parameters in the second analysis step, refusing to execute an operation of calling the data query tool corresponding to the second analysis step, wherein the first analysis step and the second analysis step are any two analysis steps in the current alarm processing process, and the second analysis step is after the first analysis step.

In some possible implementations, the execution module is further used for:
in response to associated data obtained in a third analysis step being identical to associated data obtained in a fourth step, discarding the associated data obtained in the fourth analysis step, wherein the third analysis step and the fourth analysis step are any two analysis steps in the current alarm processing process, and the fourth analysis step is after the third analysis step.

In some implementations, the obtaining module 401 is further used for:
obtaining historical alarm data from an alarm database, wherein the historical alarm data comprises alarm data of an alarm event having the same alarm type as the first alarm event, and/or alarm data similar to the key alarm data of the first alarm event;
and the communication module 404 is used for:
sending the first alarm event, the associated data obtained in each of the at least one analysis step and the historical alarm data to the first language model, and receiving the alarm analysis result output by the first language model.

In some possible implementations, the alarm database is created by:
obtaining a plurality of pieces of alarm data;
performing embedding on the plurality of pieces of alarm data, and determining vector representations corresponding to the plurality of pieces of alarm data; and
creating the alarm database based on the vector representations corresponding to the plurality of pieces of alarm data.

In some possible implementations, the processing module 405 is used for:
determining, based on the alarm analysis result, at least one processing tool and processing parameters corresponding to the at least one processing tool; and
processing the first alarm event by calling the at least one processing tool based on the processing parameters.

The alarm processing apparatus 40 according to the embodiments of the present disclosure corresponds to the method described above in the embodiments of the present disclosure. The above and other operations and/or functions of the respective modules/units of the alarm processing apparatus 40 are respectively implemented to complete corresponding processes of the method according to the embodiments shown in FIGS. 1-3. For brevity, details are omitted herein.

The embodiments of the present disclosure further provide an electronic device. The electronic device is used for implementing the functions of the alarm processing apparatus 40 according to the embodiments shown in FIG. 4.

FIG. 5 illustrates a schematic diagram of a structure of an electronic device 500. As shown therein, the electronic device 500 comprise a bus 501, a processor 502, a communication interface 503 and a memory 504. The processor 502, the memory 504 and the communication interface 503 communicate with one another via the bus 501.

The bus 501 may be a peripheral component interconnect (PCI) bus, an extended industry standard architecture (EISA) bus, or the like. The bus may be classified into an address bus, a data bus, a control bus, and the like. For ease of representation, only one bold line is used to represent the bus in FIG. 5, but this does not mean there is only one bus or only one type of bus.

The processor 502 may be a central processing unit (CPU), a graphics processing unit (GPU), a microprocessor (MP) or digital signal processor (DSP), or any one or more of the above processors.

The communication interface 503 is used for external communication. For example, the communication interface 503 may be used for communicating with a terminal.

The memory 504 may comprise a volatile memory, for example, a random access memory (RAM). The memory 504 may further comprise a non-volatile memory, for example, a read-only memory (ROM), a flash memory, a hard disk drive (HDD), or a solid state drive (SSD).

The memory 504 has executable code stored therein, and the processor 502 can execute the executable code to perform the alarm processing method described above.

For example, in the case of carrying out the embodiments shown in FIG. 4, and implementing the respective modules or units of the alarm processing apparatus 40 described in the embodiments of FIG. 4 by software, the software or the program code required for the functions of the respective modules/units in FIG. 4 may be partly or fully stored in the memory 504. The processor 502 can execute program code corresponding to the respective units stored in the memory 504, to perform the alarm processing method described above.

The embodiments of the present disclosure further provide a computer readable storage medium. The computer readable storage medium may be any available medium that can be stored by a computing device, or may be a storage device, for example, a data center, that includes one or more available media. The available medium may be a magnetic medium (e.g. a floppy disk, a hard disk, or a magnetic tape), an optical medium (e.g. a DVD), a semiconductor medium (e.g. a solid state disk), or the like. The computer readable storage medium includes instructions that instruct the computing device to perform the alarm processing method applied to the alarm processing apparatus 40 described above.

The embodiments of the present disclosure further provide a computer program product that comprises one or more computer instructions. When the computer instruction is located onto and executed by a computing device, all or a part of the processes or functions described according to the embodiments of the present disclosure are generated.

The computer instruction may be stored in the computer readable storage medium, or transmitted from a computer readable storage medium to a further computer readable storage medium. For example, the computer instruction may be transmitted from a website, computer or data center to a further website, computer or data center via wired (e.g. a coaxial cable, an optical fiber, a digital subscriber line (DSL)) or wireless (e.g. infrared, radio, microwave, or the like) means.

When the computer program product is performed by a computer, the computer performs any of the alarm processing methods described above. The computer program product may be a software installation package. If any of the alarm processing methods described above are to be applied, the computer program product can be downloaded to and executed on the computer.

The flowchart and block diagrams in the drawings illustrate the architecture, functionality and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems which perform the specified functions or acts, or combinations of special purpose hardware and computer instructions.

Related units for describing the embodiments of the present disclosure may be implemented in the form of software, or may be implemented in the form of hardware. In certain circumstances, the names of units/modules do not formulate limitation to the units per se.

The functions described above may be performed, at least in part, by one or more hardware logic components. For example, without limitation, exemplary types of hardware logic components that may be used include: field programmable gate arrays (FPGAs), application specific integrated circuits (ASICs), application specific standard products (ASSPs), systems on chip (SOCs), complex programmable logic devices (CPLDs), and the like.

In the context of this disclosure, a machine-readable medium may be a tangible medium that can contain or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More examples of a computer-readable storage medium would include an electrical connection based on one or more wires, a portable computer diskette, a hard disk, a random access memory (RAM), a read-only memory (ROM), an erasable programmable read-only memory (EPROM or flash memory), an optical fiber, a compact disc read-only memory (CD-ROM), an optical storage device, a magnetic storage device, or any suitable combination of the foregoing.

The embodiments in the Description are described in a progressive way, where emphasis of the description of each embodiment is put on the differences from other embodiments, and for same or similar parts thereof, references can be mutually made to the other embodiments. Particularly, a system or apparatus embodiment is similar to a method embodiment and therefore described briefly. For related parts, references can be made to related descriptions in the method embodiment.

It should be understood that in the present disclosure, “at least one (item)” refers to one or more and “a plurality of” refers to two or more. The term “and/or” is used for describing an association relationship between associated objects, and represents that three relationships may exist. For example, “A and/or B” may represent the following three cases: only A exists, only B exists, and both A and B exist, where A and B may be singular or plural. The character “/” generally indicates an “or” relationship between the associated objects. “At least one of the following items (pieces)” or a similar expression thereof refers to any combination of these items, including any combination of singular items (pieces) or plural items (pieces). For example, at least one of a, b, or c may indicate a, b, c, “a and b,” “a and c,” “b and c,” or “a, b, and c,” where a, b, and c may be singular or plural.

The relationship terms as used herein, for example, “first”, “second”, and the like, are only intended for distinguishing an entity or operation from a further entity or operation, but not necessarily require or imply that those entities or operations should have any of such actual relationships or orders. In addition, the terms “include”, “comprise”, or any other variant thereof are intended to cover a non-exclusive inclusion, such that a process, method, article, or device including a series of elements not only include those elements, but also cover other elements not listed explicitly, or further cover inherent elements of the process, method, article, or device. Unless specified otherwise, elements defined by the expression “including one...” do not exclude presence of additional identical elements in the process, method, article, or device including those elements.

The steps of the method or algorithm described with reference to the embodiments disclosed herein may be implemented directly with hardware or software modules executed by a processor, or a combination thereof. The software modules may be arranged in an RAM, a memory, an ROM, an electrically programmable ROM, an electrically erasable programmable ROM, a register, a hard disk, a removable disk, a CD-ROM, or a storage medium in any other form known in the art.

The previous description of the disclosed embodiments is provided to enable those skilled in the art to implement or apply the present disclosure. Various modifications to these embodiments will be readily apparent to those skilled in the art, and the generic principles defined herein may be applied to other embodiments without departing from the spirit or scope of the present disclosure. Thus, the present disclosure is not intended to be limited to the embodiments shown herein but is to be accorded the widest scope consistent with the principles and novel features disclosed herein.

I/We claim:

1. An alarm processing method, comprising:
obtaining a first alarm event;
determining at least one analysis step of the first alarm event and at least one data query tool respectively corresponding to the at least one analysis step;
extracting key alarm data from the first alarm event;
for each of the at least one analysis step, performing steps of the following: sending the key alarm data and description information of a data query tool corresponding to the analysis step to a first language model;
receiving query parameters output by the first language model; and calling, based on the query parameters, the data query tool corresponding to the analysis step, to obtain associated data;
sending the first alarm event and the associated data obtained in each of the at least one analysis step to the first language model;
receiving an alarm analysis result output by the first language model; and
processing the first alarm event based on the alarm analysis result.

2. The method of claim 1, wherein determining the at least one analysis step of the first alarm event and the at least one data query tool respectively corresponding to the at least one analysis step comprises:
identifying a target alarm type of the first alarm event;
executing an alarm analysis script corresponding to the target alarm type; and
determining the at least one analysis step of the first alarm event and the at least one data query tool respectively corresponding to the at least one analysis step.

3. The method of claim 2, wherein the alarm analysis script is determined by:
obtaining a standard operating procedure (SOP) document comprising an alarm analysis record characterized in a natural language;
sending the SOP document to a second language model to cause the second language model to identify an alarm type from the SOP document, extract an analysis step and determine a data query tool, and generate an alarm analysis script; and
receiving the alarm analysis script corresponding to the alarm type and output by the second language model.

4. The method of claim 1, wherein the first alarm event is related to at least one of a target device, a target account or a target service,
wherein the associated data comprises at least one of the following: a process log of the target device, an access behavior log of the target account or service data of the target service.

5. The method of claim 1, further comprising:
in response to the associated data obtained in the at least one analysis step hitting an alarm rule, generating a second alarm event; and
adding the second alarm event to an alarm queue, wherein the alarm queue comprises an alarm event to be processed in a current alarm processing process.

6. The method of claim 5, further comprising:
in response to a data query tool corresponding to a first analysis step being identical to a data query tool corresponding to a second analysis step, and query parameters in the first analysis step being identical to query parameters in the second analysis step, refusing to execute an operation of calling the data query tool corresponding to the second analysis step, wherein the first analysis step and the second analysis step are any two analysis steps in the current alarm processing process, and the second analysis step is after the first analysis step.

7. The method of claim 5, further comprising:
in response to associated data obtained in a third analysis step being identical to associated data obtained in a fourth step, discarding the associated data obtained in the fourth analysis step, wherein the third analysis step and the fourth analysis step are any two analysis steps in the current alarm processing process, and the fourth analysis step is after the third analysis step.

8. The method of claim 1, further comprising:
obtaining historical alarm data from an alarm database, wherein the historical alarm data comprises at least one of alarm data of an alarm event having the same alarm type as the first alarm event or alarm data similar to the key alarm data of the first alarm event,
wherein sending the first alarm event and the associated data obtained in each of the at least one analysis step to the first language model comprises:
sending the first alarm event, the associated data obtained in each of the at least one analysis step and the historical alarm data to the first language model,
wherein receiving the alarm analysis result output by the first language model comprises:
receiving the alarm analysis result output by the first language model.

9. The method of claim 8, wherein the alarm database is established by:
obtaining a plurality of pieces of alarm data;
performing embedding on the plurality of pieces of alarm data;
determining vector representations corresponding to the plurality of pieces of alarm data; and
establishing the alarm database based on the vector representations corresponding to the plurality of pieces of alarm data.

10. The method of claim 1, wherein processing the first alarm event based on the alarm analysis result comprises:
determining, based on the alarm analysis result, at least one processing tool and processing parameters corresponding to the at least one processing tool; and
processing the first alarm event by calling the at least one processing tool based on the processing parameters.

11. An electronic device, comprising:
a processor; and
a memory,
wherein the memory stores processor executable instructions which, when executed by the processor, cause the processors to:
obtain a first alarm event;
determine at least one analysis step of the first alarm event and at least one data query tool respectively corresponding to the at least one analysis step;
extract key alarm data from the first alarm event;
for each of the at least one analysis step, send the key alarm data and description information of a data query tool corresponding to the analysis step to a first language model; receive, for each of the at least one analysis step, query parameters output by the first language model; and call, for each of the at least one analysis step and based on the query parameters, the data query tool corresponding to the analysis step, to obtain associated data;
send the first alarm event and the associated data obtained in each of the at least one analysis step to the first language model;
receive an alarm analysis result output by the first language model; and
process the first alarm event based on the alarm analysis result.

12. The electronic device of claim 11, wherein the instructions to determine the at least one analysis step of the first alarm event and the at least one data query tool respectively corresponding to the at least one analysis step comprise instructions to:
identify a target alarm type of the first alarm event;
execute an alarm analysis script corresponding to the target alarm type; and
determine the at least one analysis step of the first alarm event and the at least one data query tool respectively corresponding to the at least one analysis step.

13. The electronic device of claim 12, wherein to determine the alarm analysis script, the instructions further comprise instructions to:
obtain a standard operating procedure (SOP) document comprising an alarm analysis record characterized in a natural language;
send the SOP document to a second language model to cause the second language model to identify an alarm type from the SOP document, extract an analysis step and determine a data query tool, and generate an alarm analysis script; and
receive the alarm analysis script corresponding to the alarm type and output by the second language model.

14. The electronic device of claim 11, wherein the first alarm event is related to at least one of a target device, a target account or a target service,
wherein the associated data comprises at least one of the following: a process log of the target device, an access behavior log of the target account or service data of the target service.

15. The electronic device of claim 11, wherein the instructions further comprise instructions to:
in response to the associated data obtained in the at least one analysis step hitting an alarm rule, generate a second alarm event; and
add the second alarm event to an alarm queue, wherein the alarm queue comprises an alarm event to be processed in a current alarm processing process.

16. The electronic device of claim 15, wherein the instructions further comprise instructions to:
in response to a data query tool corresponding to a first analysis step being identical to a data query tool corresponding to a second analysis step, and query parameters in the first analysis step being identical to query parameters in the second analysis step, refuse to execute an operation of calling the data query tool corresponding to the second analysis step, wherein the first analysis step and the second analysis step are any two analysis steps in the current alarm processing process, and the second analysis step is after the first analysis step.

17. The electronic device of claim 15, wherein the instructions further comprise instructions to:
in response to associated data obtained in a third analysis step being identical to associated data obtained in a fourth step, discard the associated data obtained in the fourth analysis step, wherein the third analysis step and the fourth analysis step are any two analysis steps in the current alarm processing process, and the fourth analysis step is after the third analysis step.

18. The electronic device of claim 11, wherein the instructions further comprise instructions to:
obtain historical alarm data from an alarm database, wherein the historical alarm data comprises at least one of alarm data of an alarm event having the same alarm type as the first alarm event or alarm data similar to the key alarm data of the first alarm event,
wherein the instructions to send the first alarm event and the associated data obtained in each of the at least one analysis step to the first language model comprise instructions to:
send the first alarm event, the associated data obtained in each of the at least one analysis step and the historical alarm data to the first language model,
wherein the instructions to receive the alarm analysis result output by the first language model comprise instructions to:
receive the alarm analysis result output by the first language model.

19. The electronic device of claim 18, wherein to establish the alarm database, the instructions further comprise instructions to:
obtain a plurality of pieces of alarm data;
perform embedding on the plurality of pieces of alarm data;
determine vector representations corresponding to the plurality of pieces of alarm data; and
establish the alarm database based on the vector representations corresponding to the plurality of pieces of alarm data.

20. A computer program product being stored on a non-transitory computer readable storage medium, wherein the computer program product comprises processor executable instructions which, when executed by a processor, cause the processors to:
obtain a first alarm event;
determine at least one analysis step of the first alarm event and at least one data query tool respectively corresponding to the at least one analysis step;
extract key alarm data from the first alarm event;
for each of the at least one analysis step, send the key alarm data and description information of a data query tool corresponding to the analysis step to a first language model; receive, for each of the at least one analysis step, query parameters output by the first language model; and call, for each of the at least one analysis step and based on the query parameters, the data query tool corresponding to the analysis step, to obtain associated data;
send the first alarm event and the associated data obtained in each of the at least one analysis step to the first language model;
receive an alarm analysis result output by the first language model; and
process the first alarm event based on the alarm analysis result.
